(19) United States
(12) Patent Application Publication
(10) Pub. No.: US 2023/0336258 A1
(43) Pub. Date: Oct. 19, 2023

(54) AUTOMATIC DETECTION OF INTERFERING CELLS IN A BROWN-FIELD DEPLOYMENT

(71) Applicant: Meta Platforms, Inc., Menlo Park, CA (US)

(72) Inventors: Mustafa Emin Sahin, Northridge, CA (US); Abhishek Tiwari, Oak Park, CA (US); Pratheep Bondalapati, Woodland Hills, CA (US)

(21) Appl. No.: 16/910,224

(22) Filed: Jun. 24, 2020

Related U.S. Application Data
(60) Provisional application No. 62/945,136, filed on Dec. 7, 2019.

(51) Int. Cl. H04W 24/08; H04W 24/10; H04B 17/327; H04B 17/345; H04B 17/336

(52) U.S. Cl. CPC H04B 17/345; H04B 17/327; H04B 17/336; H04W 24/08; H04W 24/10

(57) ABSTRACT

Apparatuses, methods, and systems for automatic detection of interfering cells are disclosed. One method includes monitoring, by each of a plurality of user equipment, one or more characteristic of received wireless signals, wherein the plurality of user equipment is located within a coverage area of a plurality of macro-cells of a wireless network, collecting the monitored one or more characteristics the of the received wireless signal, and adjusting operation of a macro-cell or at least one sector of a sectorized supercell base station based on the collected monitored one or more characteristics of the received wireless signals, wherein at least one sector of the sectorized supercell base station has a wireless signal coverage area that overlaps with the coverage area of plurality of macro-cells of the wireless network.

### RELATED APPLICATIONS

This patent application claims priority to US Pat. Application Serial No. 62/945,136 filed Dec. 07, 2019, which is herein incorporated by reference.

### FIELD OF THE DESCRIBED EMBODIMENTS

The described embodiments relate generally to wireless communications. More particularly, the described embodiments relate to systems, methods and apparatuses for automatic detection of interfering cells operating at the same frequency in a brown-field deployment.

### BACKGROUND

There is a constant need to improve and supplement wireless communication.

It is desirable to have methods, apparatuses, and systems for avoiding interference when overlaying the coverage area of a sectorized wireless base station with the coverage area of a cellular wireless network operating at the same frequency, in a phenomenon called brown-field deployment.

### SUMMARY

An embodiment includes a method. The method includes monitoring, by each of a plurality of user equipment, one or more characteristic of received wireless signals, wherein the plurality of user equipment is located within a coverage area of a plurality of macro-cells of a wireless network, collecting the monitored one or more characteristics of the received wireless signal, and adjusting operation of at least one sector of a sectorized supercell base station based on the collected monitored one or more characteristics of the received wireless signals, wherein at least one sector of the sectorized supercell base station has a wireless signal coverage area that overlaps with the coverage area of plurality of macro-cells of the wireless network.

Another embodiment includes a wireless network. The wireless network includes a plurality of macro-cells that provide wireless coverage, a sectorized supercell base station operating to provide a wide wireless coverage that overlaps the wireless coverage of the plurality of macro-cells, a plurality of user equipment located within the wireless coverage of the plurality of macro-cells, and within the wireless coverage of the sectorized supercell base station, wherein each of the plurality of user equipment operates to monitor one or more characteristic of received wireless signals, and a central controller. The central controller operates to collect the monitored one or more characteristics of the received wireless signals, and adjust operation of at least one sector of a sectorized supercell base station based on the collected monitored one or more characteristics of the received wireless signals, wherein at least one sector of the sectorized supercell base station has a wireless signal coverage area that overlaps with the coverage area of a plurality of macro-cells of the wireless network.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a network that includes conventional base station towers, according to an embodiment.

FIG. 2 shows a cell of a base station that includes sectoring, according to an embodiment.

FIG. 3 shows a sector of a sectorized supercell base station in which a coverage area of the sector overlays coverage areas of multiple cells of a standard cellular network, according to an embodiment.

FIG. 4 shows multiple sectors of a sectorized supercell base station that are activated over an area in which macro-cells of an existing cellular network are operating, according to an embodiment.

FIG. 5 shows a logical architecture wireless system that includes controlling operating parameters of a sectorized supercell base station based on signal measurements of user equipment, according to an embodiment.

FIG. 6 is a flowchart that includes steps of a method of detection of interfering cells and sectors, according to an embodiment.

FIG. 7 is a flow chart of a method of deciding whether to maintain activation, or to deactivate or to re-configure one or more sectors of a sectorized supercell base station having a coverage area that overlaps with a coverage area of an existing cellular network, according to an embodiment.

FIG. 8A is a table providing median RSRP (reference signal received power) and SINR (signal to interference and noise ratio) values obtained for conditions in which interfered macro-cells are activated and deactivated, and a sector of a sectorized supercell base station is activated and deactivated, according to an embodiment.

FIG. 8B is a flow chart that includes steps of a method of controlling the macro-cells and the sector of a sectorized supercell base station for the conditions of the table of FIG. 8A, according to an embodiment.

### DETAILED DESCRIPTION

The embodiments described include methods, apparatuses, and systems for detection of interfered cells of a cellular network when a sectorized wide coverage area base station (also referred to as a Supercell base station of a Supercell) is activated in an area that overlaps with the coverage area of the cellular network. For an embodiment, the interference detection is used to adjust the operation of the sectorized (Supercell) base station and/or the operation of the macro-cells to mitigate interference and to improve wireless connectivity of user equipment (UEs) connected to the cellular network. For an embodiment, the adjustment includes deactivating one or more sectors of the sectorized supercell base station or one or more macro-cells. For an embodiment, the adjustment includes reselecting or adjusting beamforming parameters of beam associated with one or more sectors of the sectorized supercell base station or one or more macro-cells. In another embodiment, the adjustment includes splitting available frequency spectrum between the interfered cell(s) and the sectors of the Supercell that cause interference. In another embodiment, the adjustment includes splitting available time between the interfered cell(s) and the sectors of the Supercell that cause interference. For at least some embodiments, the sectorized supercell base station is not synchronized with the macro-cells of the cellular network.

For an embodiment, a sectorized supercell base station is distinguishable from a macro-cell because the wireless coverage area of the sectorized supercell base station, and the number of sectors of the sectorized supercell base station are greater than any of the macro-cells of the wireless network.

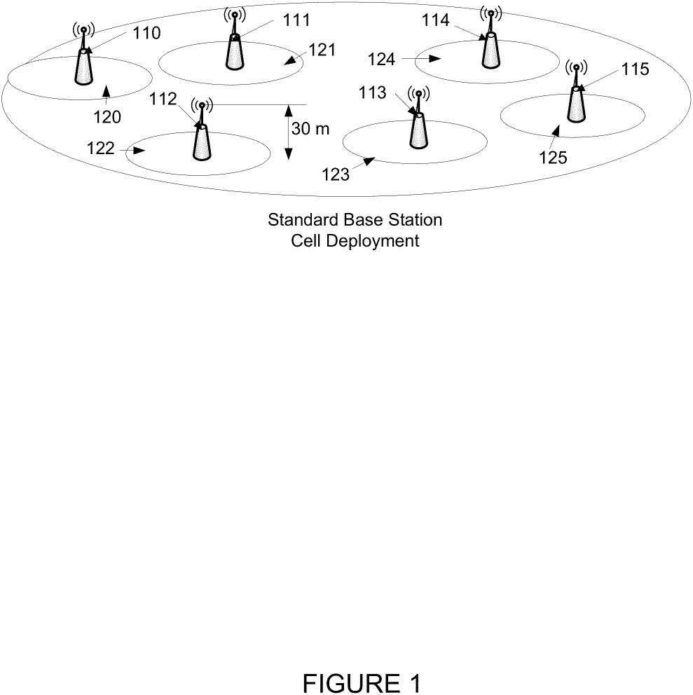

FIG. 1 shows a network that includes conventional base station towers, according to an embodiment. For an embodiment, the standard base stations 110, 111, 112, 113, 114, 115, have a height, and therefore, an antenna elevation of about 30-60 meters. Further, each of the standard base stations has a cell coverage area 120, 121, 122, 123, 124, 125.

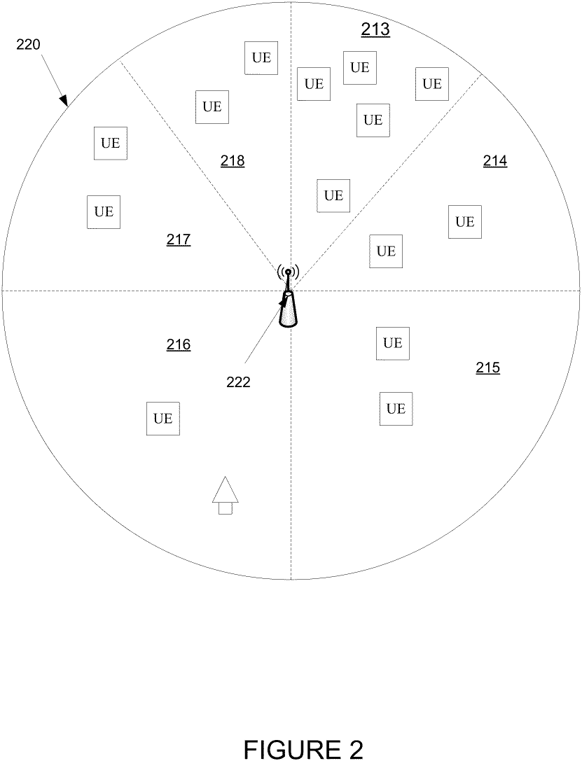

FIG. 2 shows a cell of a base station that includes sectoring, according to an embodiment. As shown, the coverage area 220 of the sectorized supercell base station 222 is divided into sectors 213, 214, 215, 216, 217, 218 wherein each sector covers a section of the total coverage area 220 of cell of the base station 222. Generally, for an embodiment, each sector includes a radio and an array of antennas that operate to form a beam in which wireless signals can be transmitted and/or received from wireless devices. For an embodiment, the width of the beam is directly related to the gain of the sector beam and therefore to the coverage area of the sector. For an embodiment, the sectorized supercell base station 222 is taller than the standard base stations of cell coverage areas 120, 121, 122, 123, 124, 125.

Elevating base stations to greater heights above ground and by using the high gain of narrow beam width sectors provides improved propagation (ranges of 20-75 km) and presents an opportunity to reduce the total cost of ownership for the network infrastructure operator by deploying fewer elevated base stations to cover the same area. Further, improved propagation (coverage) range provided by an elevated base station requires the base station to serve greater capacity to satisfy the demand. For an embodiment, the sectorized supercell base stations have a greater height than the cellular base stations.

For at least some embodiments, the tall base stations form super cells that are much larger than cells formed by standard cellular networks. For an embodiment, high-order sectoring can be provided by a Luneburg lens antenna. Further, for an embodiment, the antenna includes a high-power amplifier array. Further, base band processing of the base station can be located at a lower elevation than the antenna array of the base station, and communication signals and power can be provided to the antenna array through a fiber. Further, the described embodiments of sectorization can be waveform agnostic and allow the wireless base station to support wireless communication standards that do not utilize channel state information.

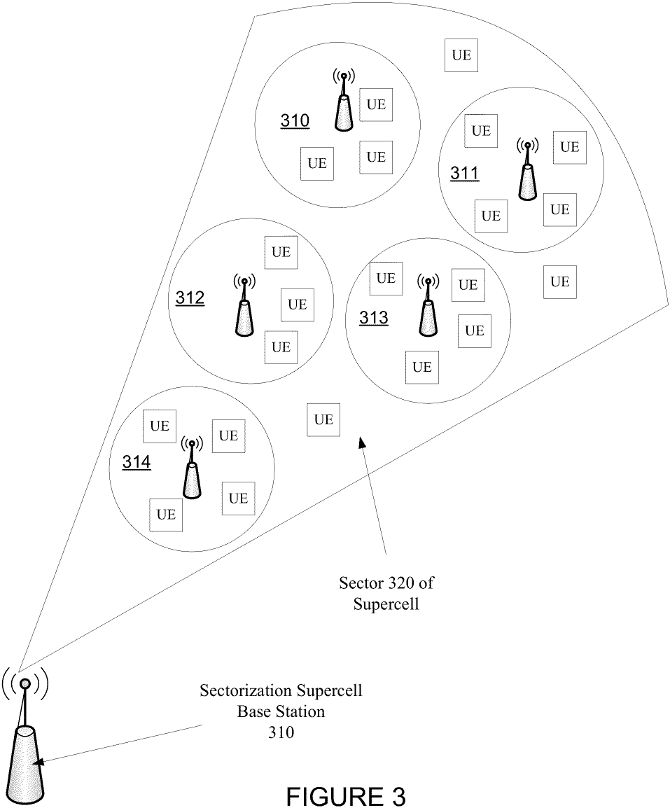

FIG. 3 shows a sector 320 of a sectorized supercell base station 310 in which a coverage area of the sector 320 overlays coverage areas of multiple cells 310, 311, 312, 313, 314 of a standard cellular network, according to an embodiment. As shown, the user equipment (UEs) are provided with wireless coverage by the cellular base stations of the wireless cells 310, 311, 312, 313, 314, and/or by the sector 320 of a Supercell formed by the sectorized supercell base station 310. Accordingly, each of the user equipment UEs can wirelessly communicate with the cellular base stations of the wireless cells 310, 311, 312, 313, 314, and/or with the sector 320 of the sectorized supercell base station 310. It is to be understood that for at least some embodiment, the cellular base stations can have sectors, as well.

For at least some embodiments, beamforming parameters of the beamforming pattern of the sector 320 are selected based at least on the locations of the plurality of wireless devices (UEs), wherein the selected beamforming parameters control at least a sector selection and the width of the beamforming pattern of the sector. The direction and width of the beamforming pattern is determined by the beamforming parameters, and accordingly, the coverage area of each sector is determined by the beamforming parameters. The locations of the wireless devices can be used to determine the desired coverage area, and therefore, the beamforming parameters of activated sectors. That is, activation (selection) of the sector 320 and the direction, and width of the sector 320 are controlled by the beamforming parameters of the sector 320. That is, broadcast coverage area of the sector 320 is controlled by the beamforming parameters which can include, for example, the selection of phase and amplitude of signals being communicated through the multiple antennas of the sectorized supercell base station of the sector 320.

Generally, for at least some embodiments, the plurality of cellular base stations (such as the base stations of the wireless cells 310, 311, 312, 313, 314) provide wireless access to a plurality of wireless devices (such as, the user equipment (UEs) of FIG. 3) over a coverage area. The sectorized supercell base station (such as, the Supercell of the sector 320) provides wireless communication to the plurality of wireless devices over at least the coverage area, wherein the sectorized supercell base station includes a plurality of antennas operating to form a plurality of sectors, wherein each sector of the plurality of antennas operates to cover a selectable coverage area as determined by a width of a beamforming pattern formed by a subset of the plurality of antennas of the sector. Locations of each of the plurality of wireless devices are identified. Beamforming parameters of the beamforming pattern are selected based at least on the locations of the plurality of wireless devices, wherein the selected beamforming parameters control at least a sector selection and the width of the beamforming pattern of the sector. At least some embodiments include the ability to physically tilt the plurality of antennas to redirect the beam.

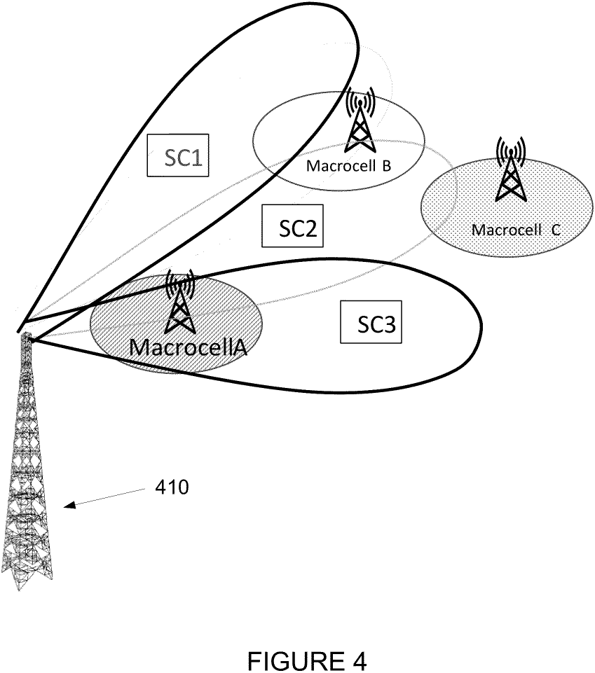

FIG. 4 shows multiple sectors SC1, SC2, SC3 of a sectorized supercell base station 410 that are activated over an area in which macro-cells (A, B, C) of an existing cellular network are operating, according to an embodiment. At least some embodiments include deploying the sectorized (Supercell) based station with a coverage area that overlays existing deployed macro-cells, which can be referred to as a brown-field umbrella cell (or Supercell) deployment. The deployment of the sectorized (Supercell) based station can improve the wireless communication provided to the user equipment wirelessly connected to the macro-cells (A, B, C). However, the deployment of the sectorized (Supercell) based station can also cause interference with the wireless communication of some of the macro-cells (A, B, C). Therefore, a determination of which of the sectors SC1, SC2, SC3 and the macro-cells (A, B, C) interfere with each other is needed.

For at least some embodiments, the determination of the interfering sectors SC1, SC2, SC3 and the macro-cells (A, B, C) is automated. Further, once information about the determination of the interfering sectors SC1, SC2, SC3 and the macro-cells (A, B, C) is obtained, this information can be used to control the sectors and macro-cells to mitigate the interferences. Techniques available for mitigation include adjustments in inter-cell interference avoidance and cancellation parameters such as the spectrum allocated to macro-cells and Supercell sectors, changes in hand over and cell reselection parameters such as cell-individual-offsets, and modifications in antenna tilt values.

As described, for at least some embodiments, the multiple sectors SC1, SC2, SC3 of the sectorized supercell base station 410 are activated over the area in which macro-cells (A, B, C) of the existing cellular network are operating. For an embodiment, the activated multiple sectors SC1, SC2, SC3 of the sectorized supercell base station operate (transmit and/or receive wireless signals to and from UEs within the overlapping area) over a same or common set of frequencies as the macro-cells (A, B, C) of the existing cellular network. Accordingly, the sectors SC1, SC2, SC3 may interfere with the wireless communication of the macro-cells (A, B, C). For at least some embodiments, the interference is mitigated by dividing a frequency spectrum that has been allocated to the network, timing of wireless communication of the both the sectors SC1, SC2, SC3 and the macro-cells (A, B, C) is scheduled (time allocated), or parameters of the beamforming of the sectors SC1, SC2, SC3 are adjusted.

For at least some embodiments, after activating the sectors SC1, SC2, SC3 and determining the level of interference of the UEs within the coverage areas of the macro-cells (A, B, C) caused by the activated sectors, one or more of actions can be performed. If the interference is determined to be less than a first threshold, then it may be determined that the activation of the sectors SC1, SC2, SC3 improves the overall connectivity of UEs within the coverage area of the macro-cells (A, B, C), and no further action is taken. If the interference is determined to be greater than the first threshold, one of several possible actions can be taken. For an embodiment, the next action (after determining the level of interference is greater than the first threshold) includes adjusting beamforming parameters of one or more of the activated sectors SC1, SC2, SC3. One possible action includes turning off (de-activating) one of more of the activated sectors. Another possible action includes modifying beamforming parameters of one or more of the activated sectors SC1, SC2, SC3. For example, a predetermined set of possible antenna tilt values can be used for this purpose.

For at least some embodiments, when an umbrella cell (sectorized supercell base station or Supercell) is activated (turned on) in the same (overlapping) area with wireless signals operating at the same carrier frequencies, user equipment (UE) within the area will measure a detectable change in signal strength and quality. For at least some embodiments, the detectable changes include an increase in the strength of the received signal (RSSI), for example, by 1 dB (25%), 2 dB (60%), or 3 dB (100%) and a decrease in the signal quality indicated by the signal to interference plus noise ratio (SINR). For an embodiment, the level of SINR decrease can be used as a trigger to decide about severity of inter-cell interference (ICI) from Supercell.

For at least some embodiments, when an umbrella cell (sectorized supercell base station or Supercell) is activated (turned on) in the same (overlapping) area with wireless signals operating at the same carrier frequencies, some UEs will connect to a sector of the Supercell although the UEs are still in the same location as before the Supercell was turned on. Further, for an embodiment, UEs that were previously connected to a macro-cell and then connect to the sector of the Supercell indicate interference between those sectors and the macro-cell. For an embodiment, the severity of the interference between the Supercell sector and the macro-cell is revealed by the percentage of UEs that migrate from macro-cell to sectors of the Supercell.

For at least some embodiments, when an umbrella cell (sectorized supercell base station or Supercell) is activated (turned on) in the same (overlapping) area with wireless signals operating at the same carrier frequencies, three types of users (UEs) will result. A first type (A) includes new Supercell users who were previously unconnected. A second type (B) includes users whose SINR has improved (that is, ex-macro-cell users who are now on Supercell users and have a resulting better SINR). A third type (C) includes users whose SINR has degraded (that is, macro-cell users suffering Supercell interference and ex-macro-cell users who are now Supercell users but receive worse SINR). For an embodiment, a figure of merit can be calculated as M = (A + B) / C. For an embodiment, if the figure of merit is less than a certain threshold (for example, if M < 0.5, that is, when the figure indicates that the activation of the Supercell hurts significantly more users than it helps), certain actions can be triggered. In one such action the corresponding Supercell sector can be turned off. Other such actions include adjustments in ICIC parameters, changes in cell configuration parameters, and modifications in antenna tilt values.

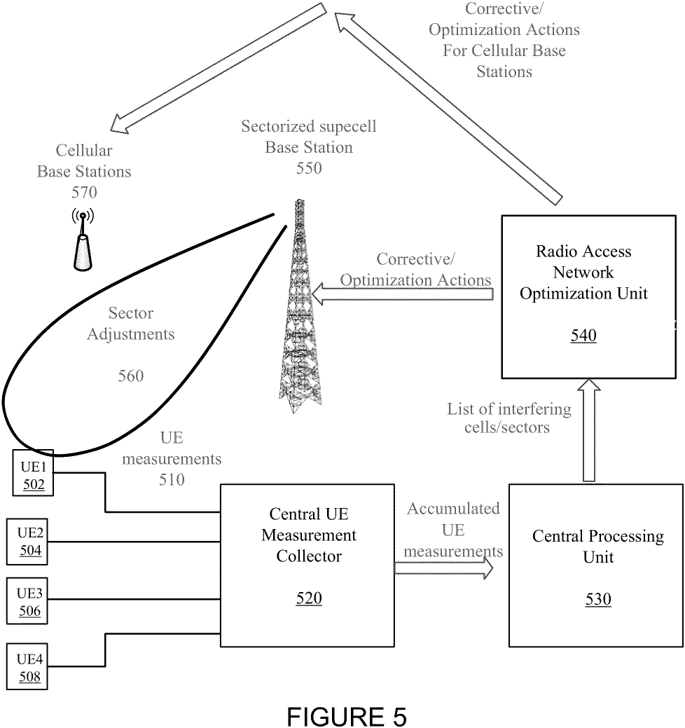

FIG. 5 shows a logical architecture wireless system that includes controlling operating parameters of a sectorized supercell base station based on signal measurements of user equipment, according to an embodiment. The wireless system includes multiple UEs 502, 504, 506, 508 that sense and measure signal quality parameters of wireless signals being used for wireless communication with the UEs 502, 504, 506, 508. Further, the UEs 502, 504, 506, 508 can determine their location through, for example, global positioning system (GPS) receivers.

For an embodiment, the UE measurements 510 are provided to a central UE measurement collector 520. For an embodiment, the central UE measurement collector 520 includes a central tool (software) that collects certain UE data and measurements such as RSSI, SINR, Physical Cell Identity (PCI) of the serving cell, and/or latitude and longitude of the corresponding UE.

For an embodiment, a central processing unit 530 uses the collected data and detects the interfering macro-cells and Supercell (sectorized supercell base station) sectors. Alternatively, or additionally, for an embodiment, the central processing unit 530 calculates the figure of merit for each Supercell (sectorized supercell base station) sector after activation.

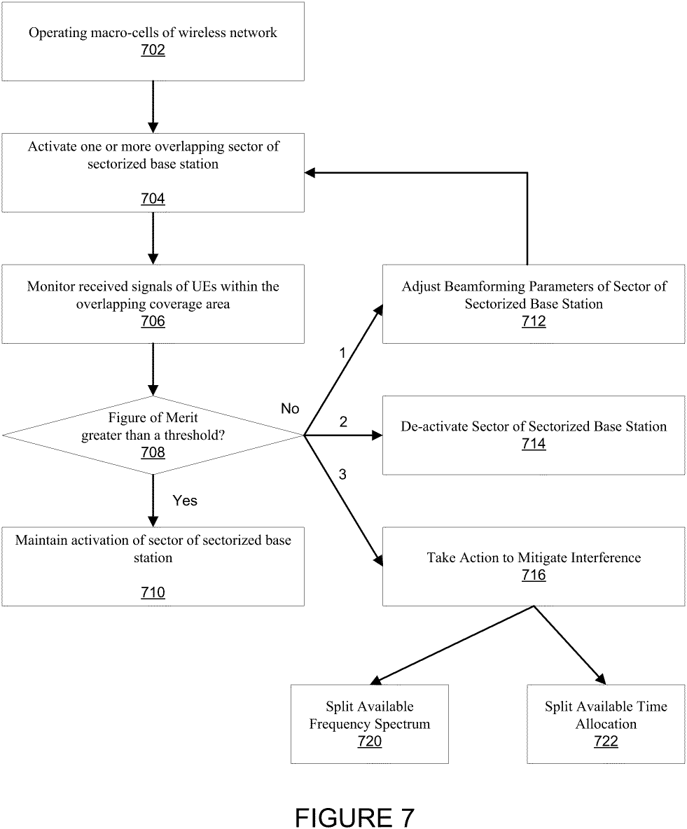

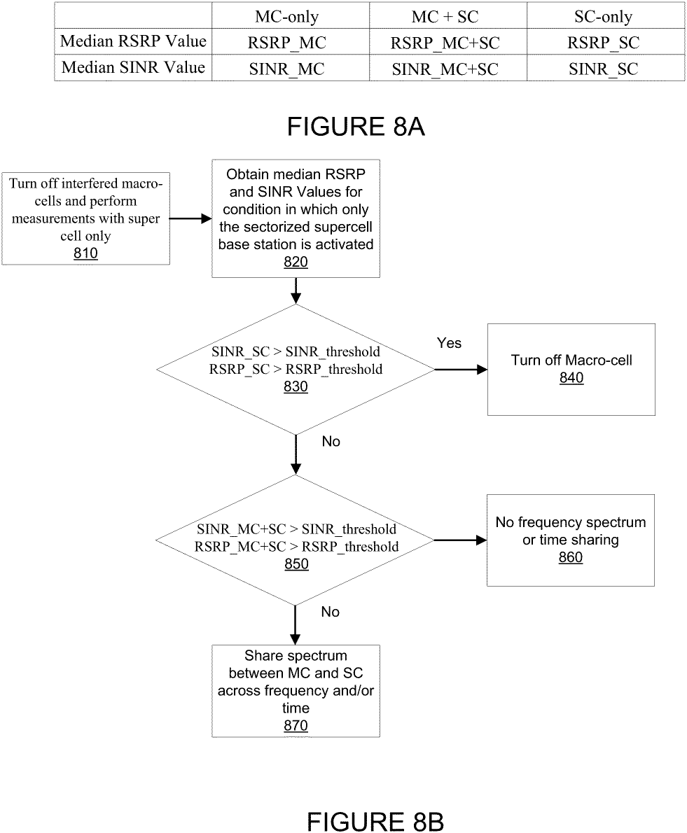

For an embodiment, Radio Access Network (RAN) Optimization Unit 540 receives the information of interfering cells/sectors and sends corrective/optimization actions to the corresponding sectorized supercell base station 550. For at least some embodiments, the Radio Access Network (RAN) Optimization Unit 540 sends corrective/optimization actions to the interfered macro-cells 570 as well. The corrective actions (such as, sector adjustments 560) can include the deactivation of problem causing sectors of the corresponding sectorized supercell base station 550. Further, the correction actions can include frequency and/or time splitting between the interfered macro-cells and the sectorized supercell base station 550. Further, the corrective action can include adjustment of antenna beamforming parameters of the sectorized supercell base station 550 (including adjusting a physical tilt of the antenna array of the sectorized supercell base station 550. FIGS. 7, 8 elaborates on interference mitigation processes that can be performed by the Radio Access Network (RAN) Optimization Unit 540.

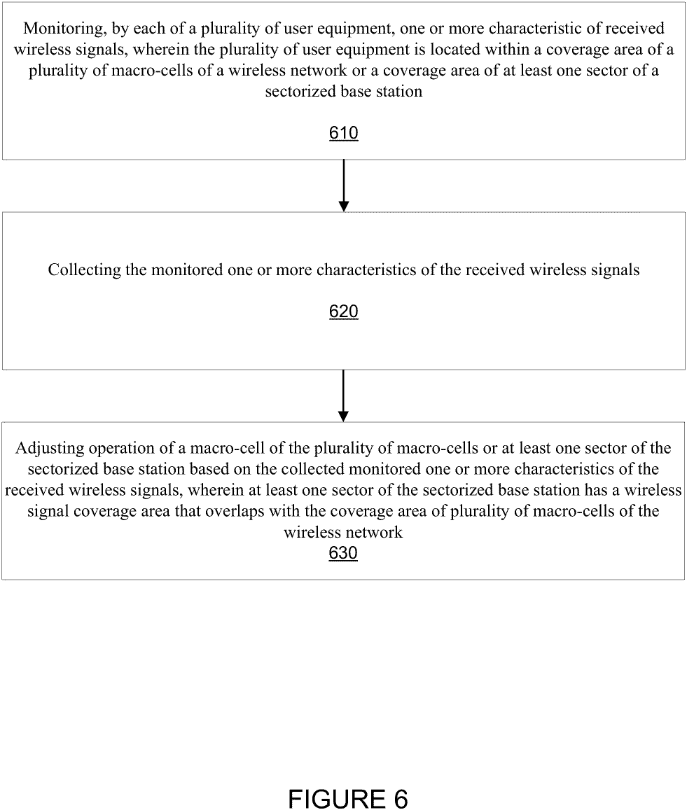

FIG. 6 is a flow chart that includes steps of a method of detection of interfering cells and sectors, according to an embodiment. A first step 610 includes monitoring, by each of a plurality of user equipment, one or more characteristic of received wireless signals, wherein the plurality of user equipment is located within a coverage area of a plurality of macro-cells of a wireless network or the supercell. A second step 620 includes collecting the monitored one or more characteristics of the received wireless signals. A third step 630 includes adjusting operation of a macro-cell or at least one sector of a sectorized supercell base station based on the collected monitored one or more characteristics of the received wireless signals, wherein the at least one sector of the sectorized supercell base station has a wireless signal coverage area that overlaps with the coverage area of plurality of macro-cells of the wireless network.

For at least some embodiment, at least one sector of the sectorized supercell base station is activated while the plurality of macro-cells of a wireless network is operating to wirelessly communicate with the plurality of user equipment. That is, the plurality of macro-cells is previously deployed and operating to provide wireless communication to the user equipment. The sectorized supercell base station is later deployed to provide connectivity to users who are not covered by any macro-cell and to enhance the wireless communication for already connected users. For an embodiment, the at least one sector of the sectorized supercell base station broadcasts wireless signals to supplement the wireless communication to the user equipment. Some user equipment will experience enhanced wireless communication, while others may suffer from interference. Steps can be taken after deploying (activating) the at least one sector of the sectorized supercell base station to mitigate the interference suffered by at least some of the user equipment.

For at least some embodiment, the monitored one or more characteristics include at least a received signal strength of the received wireless signals, or an interference measurement of the received wireless signals. For an embodiment, one or more of the user equipment monitor the levels of received signal power and/or interference. For an embodiment, the one or more user equipment report the monitored received signal power and/or interference. Steps for identifying and mitigating the interference are then performed.

At least some embodiments further include monitoring which of the user equipment of the plurality of user equipment migrate from maintaining a wireless connection to the plurality macro-cells of a wireless network to maintaining a wireless connection to at least one sector of the sectorized supercell base station after at least one sector of the sectorized supercell base station is activated. That is, after activating the at least one sector of the sectorized supercell base station, some of the user equipment will experience improved wireless connections while others will suffer worse wireless connections due to interference.

For at least some embodiments, a level of interference between the plurality of macro-cells of the wireless network and at one least sector of the sectorized supercell base station is estimated based on a percentage of the user equipment that migrate to the at one least sector of the sectorized supercell base station. Corrective actions can be taken based on the percentage.

At least some embodiments further include determining a number (A) of user equipment devices that connect to a sector of the sectorized supercell base station after the at least one sector of the sectorized supercell base station is activated, a number (B) of user equipment that experience an improved signal-to-noise-ratio (SNR) after the at least one sector of the sectorized supercell base station is activated, and a number (C) of user equipment that experience a worse signal-to-noise-ratio (SNR) after the at least one sector of the sectorized supercell base station is activated. For at least some embodiments a figure of merit is determined based on A, B and C. For at least some embodiments, the at least one sector of the super cell base station is maintained as active if the figure of merit is greater than a selected threshold, and the at least one sector of the super cell base station is deactivated if the figure of merit is less than the selected threshold.

For at least some embodiments, a central UE measurement collector collects the monitored one or more characteristics the received wireless signals, a central processing unit processes the monitored one or more characteristics, and a radio access network optimization unit controls operation of at least one sector of the sectorized supercell base station based on the processed monitored one or more characteristics.

At least some embodiments further include determining, by the radio access network optimization unit, that the previously described figure of merit is below a merit threshold, or a level of interference of the UEs is greater than a threshold based on the monitored one or more characteristics, and mitigating, by the radio access network optimization unit, the interference caused when the at least one sector of the sectorized supercell base station is activated if the figure of merit is below the merit threshold or the level of interference is above the threshold. For an embodiment, this includes allocating, by the radio access network optimization unit, a first portion of available frequency spectrum to the plurality of macro-cells of the wireless network, and allocating, by the radio access network optimization unit, a second portion of the available frequency spectrum to the at least one sector of the sectorized supercell base station, wherein the first portion and the second portion do not overlap in the available frequency spectrum.

At least some embodiments further include determining, by the radio access network optimization unit, that the previously described figure of merit is below a merit threshold, or a level of interference of the UEs is greater than a threshold based on the monitored one or more characteristics, and mitigating, by the radio access network optimization unit, the interference caused when the at least one sector of the sectorized supercell base station is activated if the figure of merit is below the merit threshold or the level of interference is above the threshold. For at least some embodiments, this includes allocating, by the radio access network optimization unit, a first portion of an allocated time period to the plurality of macro-cells of the wireless network, and allocating, by the radio access network optimization unit, a second portion of the allocated time period to at least one sector of the sectorized supercell base station, wherein the first portion and the second portion do not overlap in the allocated time period.

As depicted in FIG. 8, at least some embodiments further include measuring, by each of the plurality of user equipment, an RSRP_MC (reference signal received power) and an SINR_MC (signal to interference and noise ratio) while the plurality of macro-cells is activated and the at least one sector of a sectorized supercell base station is de-activated, measuring, by each of the plurality of user equipment, an RSRP_MC+SC and an SINR_MC+SC while the plurality of macro-cells is activated and the at least one sector of a sectorized supercell base station is activated, and measuring, by each of the plurality of user equipment, an RSRP_SC (reference signal received power) and an SINR_SC (signal to interference and noise ratio) while the plurality of macro-cells is deactivated and at least one sector of a sectorized supercell base station is activated. Based on the median values of these measurements, at least some embodiments further include turning off the plurality of macro-cells when the RSRP_SC is above an RSRP threshold and the SINR_SC is above an SINR threshold, and sharing a frequency spectrum allocation between the plurality of macro-cells and the at least one sector of a sectorized supercell base station when the RSRP_SC is below the threshold or the SINR_SC is below the threshold, and the RSRP_MC+SC is below the RSRP threshold or the SINR_MC+SC is below the SINR threshold.

FIG. 7 is a flow chart of a method of activating one or more sectors of a sectorized supercell base station having a coverage area that overlaps with a coverage area of an existing cellular network, according to an embodiment. A first step 702 identifies an existing operating cellular network that includes a plurality of macro-cells operating to provide wireless connection for a plurality of UEs. A second step 704 includes activating one or more sectors of a sectorized supercell base station, wherein a coverage area of the one or more sectors overlaps a coverage area of the plurality of macro-cells. A third step 706 includes monitoring signal characteristics of the UEs within the overlapping coverage area. As previously described, for an embodiment, the UEs report the signal characteristics to a central processing unit. For an embodiment, the central processing unit calculates, determines, or estimates a level of interference based on the reported signal characteristics. A fourth step 708 includes determining whether the previously described figure of merit is above a merit threshold, or the interference is below a predetermined threshold.

As previously described, for an embodiment, the UEs report levels of interference after the activating of the one or more sectors of a supercell base station. As previously described, a central controller can determine a figure of merit based on reporting from the UEs.

For an embodiment, if the figure of merit is above the predetermined (merit) threshold, then the activated one or more sectors of the supercell base station remain activated. That is, it is determined that the activating the overlapping one or more sectors improves the wireless connectivity performance of the wireless network. Therefore, no further action is necessary.

If the figure of merit is below the predetermined threshold, one of several actions may be taken to mitigate the interference.

A first possible interference mitigate process includes a step 712 which includes adjusting beamforming pattern characteristics of the one or more sectors of the sectorized supercell base station. That is, the one or more sectors each include a beam direction and a beam width, each of which can be adjusted by adjusting a phase and/or amplitude of signals driving each of the antenna elements of the antenna arrays associated with each of the sectors. These adjustments can be referred to as adjusting the beamforming parameters, and act to adjust the corresponding beams of the one or more sectors. The change in beamforming direction and width will act to change the interference experienced by the UEs. After step 712, step 706 is performed again, and step 708 is performed again, to determine whether the interference of the UEs has improved, and whether the interference is below the threshold. Steps 712, 706, 708 can be repeated a selected number of times. If the interference cannot be brought down below the threshold after the selected number of tries at adjusting the beamforming parameters, the one or more sectors of the sectorized supercell base station can be de-activated.

For an embodiment, the adjusting of the beamforming parameter includes physically adjusting a tilt of one of more antenna arrays associated with one or more of the sectors.

Another possible interference mitigate process includes a step 714 which includes directly de-activating the one or more sectors of the sectorized supercell base station.

Another possible interference mitigate process includes a step 716 which can include a step 720 that includes splitting an available frequency spectrum between the macro-cells and the one or more sectors of the sectorized supercell base station, or can include a step 722 that includes splitting an available allotment of time between the macro-cells and the one or more sectors of the sectorized supercell base station. For an embodiment, a set allocation of frequency spectrum is allocated to the wireless network. Splitting of the frequency spectrum includes allocating a selection portion of the allocated frequency spectrum to the macro-cells, and allocating the rest of the allocated frequency spectrum to the one or more sectors of the sectorized supercell base station. For an embodiment, the splitting is dependent which of the macro-cells or the one or more sectors of the sectorized supercell base station provide the most efficient wireless communication with the UEs. If the wireless communication provided by the macro-cells is determined to be more efficient, the frequency or time allocation to the macro-cells can be greater. If the wireless communication provided by the one or more sectors of the sectorized supercell base station is determined to be more efficient, the frequency or time allocation to the one or more sectors of the sectorized supercell base station can be greater. For at least some embodiments, the frequency spectrum and/or time allocation between the macro-cells and the sectorized supercell base station is determined based on load demands (amount of requested uplink and/or downlink data) of the macro-cells and the sectorized supercell base station. Generally, the greater the load demand, the more frequency and/or time allocated to either the macro-cells and/or the sectorized supercell base station.

FIG. 8A is a table depicting RSRP (reference signal received power) and SINR (signal to interference and noise ratio) for conditions in which interfered macro-cells are activated and deactivated, and a sector of a sectorized supercell base station is activated and deactivated, according to an embodiment. A first column provides a median RSRP and a median SINR of UEs when only the macro-cells are activated. These measurements can be made, for example, before the sector of the sectorized supercell base station has been activated. A second column provides a median RSRP and a median SINR of UEs when the macro-cells and the sector of the sectorized supercell base station are all activated. These measurements can be made, for example, after the sector of the sectorized supercell base station has been activated. A third column provides a median RSRP and a median SINR of UEs when only the sector of the sectorized supercell base station is activated. That is, the interfered macro-cells can be deactivated, and the measurements of median RSRP and a median SINR performed. The median values can be determined based on the values of multiple UEs and/or the multiple UEs over time. The wireless signals communicated from the macro-cells and from the sector(s) of the sectorized supercell base station are distinguishable and identifiable. Therefore, the UEs are able to identify signal received from macro-cells from signals received from the sector(s) of the sectorized supercell base station. Therefore, reference signals received from macro-cells and reference signals received from the sector(s) of the sectorized supercell base station can be identified and the RSRP received from both can be measured.

FIG. 8B is a flow chart that includes steps of a method of controlling the macro-cells and the sector of a sectorized supercell base station for the conditions of the table of FIG. 8A, according to an embodiment. As shown, after determining interfering macro-cells through interference measurements or based on the determined figure of merit, a first step 810 includes turning off the interfered macro-cells, and performing interference measurements with only the sector of the sectorized supercell base station activated. A second step 820 includes measuring or determining the RSRP (reference signal received power) and the SINR (signal to interference and noise ratio) for each of the three conditions of the table of FIG. 8A. That is, before and after activation of the at least one sector of the sectorized supercell base station. Specifically, the RSRP and the SINR are determined when the macro-cell (MC) only is active, when the MC and the supercell (SC) are active, and when only the SC is active. Based on these measurements, interference mitigation processes can be initiated.

A third step 830 includes determining whether the SINR_SC and the RSRP_SC of the third column of the table of FIG. 8A are above a predetermined threshold. If yes, then a fourth step 840 includes turning the macro-cells off. The sector of the sectorized supercell base station provides a desired level of wireless connection quality to the UEs without the macro-cells. Therefore, the macro-cells are deactivated.

If the SINR_SC and the RSRP_SC of the third column of the table of FIG. 8A are below the predetermined threshold, then fifth step 850 is executed that includes determining whether the SINR_MC+SC and the RSRP_MC+SC of the second column of the table of FIG. 8A are above a predetermined threshold. If yes, then a sixth step 860 includes operating both the macro-cells and the sector of the sectorized supercell base station over common frequency spectrum and time. That is, activation of one of the macro-cells and the sector of the sectorized supercell base station does not substantially hinder (interfere) with the operation of the other of the macro-cells and the sector of the sectorized supercell base station. Therefore, the two can co-exist, and allocation of frequency spectrum and/or time is not required.

If the SINR_MC+SC and the RSRP_MC+SC of the second column of the table of FIG. 8A are below the predetermined threshold, then seventh step 870 is executed that includes sharing the frequency spectrum and/or time as previously described. The two cannot co-exist, and allocation of frequency spectrum and/or time is needed.

Although specific embodiments have been described and illustrated, the embodiments are not to be limited to the specific forms or arrangements of parts so described and illustrated. The described embodiments are to only be limited by the claims.

What is claimed is:

1. A method comprising:
providing, by a plurality of macro-cells of a wireless network, wireless access to a plurality of user equipment over a coverage area;
activating at least one sector of thea sectorized supercell base station while the plurality of macro cells are providing wireless access to the plurality of user equipment, wherein the at least one sector of the sectorized supercell base station comprises a wireless signal coverage area that overlaps with the coverage area of the plurality of macro-cells of the wireless network;
monitoring, by the plurality of user equipment, after activating the at least one sector of the sectorized supercell base station one or more characteristic of received wireless signals;
collecting the one or more characteristics of the received wireless signals;
determining a level of interference of the plurality of user equipment within the coverage area caused by activating the at least one sector based on the one or more characteristics after activating the at least one sector; and
adjusting operation of the at least one sector of thea sectorized supercell base station based on the determined level of interference of the plurality of user equipment within the coverage area caused by activating the at least one sector.

2. (canceled)

3. The method of claim 1, wherein the one or more characteristics include at least a received signal strength of the received wireless signals, or an interference measurement of the received wireless signals.

4. The method of claim 1, further comprising monitoring which of the user equipment of the plurality of user equipment migrate from maintaining a wireless connection to at least one of the plurality of macro-cells of the wireless network to maintaining a wireless connection to the at least one sector of the sectorized supercell base station caused by the activation of the at least one sector of the sectorized supercell base station.

5. The method of claim 4, wherein a level of interference between the plurality of macro-cells of the wireless network and the at least onea sector of the sectorized supercell base station is estimated based on a percentage of user equipment that migrate to the at least one sector of the sectorized supercell base station due to the activation of the at least one sector of the sectorized supercell base station.

6. The method of claim 3, further comprising determining:
a number (A) of user equipment that connect to a sector of the sectorized supercell base station after the at least one sector of the sectorized supercell base station is activated;
a number (B) of user equipment that experience an improved signal-to-noise-ratio (SNR) after the at least one sector of the sectorized supercell base station is activated; and
a number (C) of user equipment that experience a worse signal-to-noise-ratio (SNR) after the at least one sector of the sectorized supercell base station is activated.

7. The method of claim 6, wherein a figure of merit is determined based on A, B and C, and wherein the at least one sector of the super cell base station is maintained as active if the figure of merit is greater than a selected threshold, and the at least one sector of the super cell base station is deactivated if the figure of merit is less than the selected threshold.

8. (canceled)

9. The method of claim 7, further comprising:
determining, by the radio access network optimization unit, that the figure of merit is below a threshold;
mitigating, by the radio access network optimization unit, interference caused when the at least one sector of the sectorized supercell base station is activated if the figure of merit is below a threshold, comprising:
allocating, by the radio access network optimization unit, a first portion of available frequency spectrum to the plurality of macro-cells of the wireless network; and
allocating, by the radio access network optimization unit, a second portion of the available frequency spectrum to the at least one sector of the sectorized supercell base station, wherein the first portion and the second portion do not overlap in the available frequency spectrum.

10. The method of claim 8, further comprising:
determining, by the radio access network optimization unit, that the figure of merit is below a threshold;
mitigating, by the radio access network optimization unit, interference caused when the at least one sector of the sectorized supercell base station is activated if the figure of merit is below a threshold, comprising:
allocating, by the radio access network optimization unit, a first portion of an allocated time period to the plurality of macro-cells of the wireless network; and
allocating, by the radio access network optimization unit, a second portion of the allocated time period to the at least one sector of the sectorized supercell base station, wherein the first portion and the second portion do not overlap in the allocated time period.

11. The method of claim 1, further comprising:
measuring, by the plurality of user equipment, an RSRP_MC (reference signal received power) and an SINR_MC (signal to interference and noise ratio) while the plurality of macro-cells is activated and the at least one sector of a sectorized supercell base station is de-activated;
measuring, by the plurality of user equipment, an RSRP_MC+SC and an SINR_MC+SC while the plurality of macro-cells is activated and the at least one sector of a sectorized supercell base station is activated;
measuring, by the plurality of user equipment, an RSRP_SC (reference signal received power) and an SINR_SC (signal to interference and noise ratio) while the plurality of macro-cells is deactivated and the at least one sector of a sectorized supercell base station is activated;
turning off the plurality of macro-cells when the median RSRP_SC is above an RSRP threshold and the median SINR_SC is above an SINR threshold; and
sharing a frequency spectrum allocation between the plurality of macro-cells and the at least one sector of a sectorized supercell base station when the median RSRP_SC is below the threshold or the median SINR_SC is below the threshold, and the median RSRP_MC+SC is below the RSRP threshold or the median SINR_MC+SC is below the SINR threshold.

12. A wireless network comprising:
a plurality of macro-cells configured to provide wireless access to a plurality of user equipment over a coverage area;
a sectorized supercell base station configured, when activating at least one sector of the sectorized supercell base station, to_provide wireless coverage that overlaps the wireless coverage of the plurality of macro-cells;
the plurality of user equipment located within the wireless coverage of the plurality of macro-cells, and within the overlapping wireless coverage of the sectorized supercell base station;
wherein the plurality of user equipment operates to monitor one or more characteristics of received wireless signals;
a controller configured to:
collect the one or more characteristics of the received wireless signals;
determine a level of interference of the plurality of user equipment within the coverage area caused by activating the at least one sector based on the one or more characteristics after activating the at least one sector; and
adjust operation of the at least one sector of the sectorized supercell base station based on the determined level of interference of the plurality of user equipment within the coverage area caused by activating the at least one sector.

13. (canceled)

14. The wireless network of claim 12, wherein the one or more characteristics include at least a received signal strength of the received wireless signals, or an interference measurement of the received wireless signals.

15. The wireless network of claim 12, wherein the controller is further configured to monitor which of the user equipment of the plurality of user equipment migrate from maintaining a wireless connection to the plurality macro-cells of a wireless network to maintaining a wireless connection to the at least one sector of the sectorized supercell base station caused by the activation of the at least one sector of the sectorized supercell base station.

16. The wireless network of claim 15, wherein a level of interference between the plurality of macro-cells of the wireless network and the at least one sector of the sectorized supercell base station is estimated based on a percentage of user equipment that migrate to the at least one sector of the sectorized supercell base station caused by the activation of the at least one sector of the sectorized supercell base station.

17. The wireless network of claim 14, wherein the controller is further configured to determine:
a number (A) of user equipment that connect to a sector of the sectorized supercell base station after at least one sector of the sectorized supercell base station is activated;
a number (B) of user equipment that experience an improved signal-to-noise-ratio (SNR) after at least one sector of the sectorized supercell base station is activated; and
a number (C) of user equipment that experience a worse signal-to-noise-ratio (SNR) after the at least one sector of the sectorized supercell base station is activated.

18. The wireless network of claim 17, wherein a figure of merit is determined based on A, B and C, wherein the at least one sector of the super cell base station is maintained as active if the figure of merit is greater than a selected threshold, and the at least one sector of the super cell base station is deactivated if the figure of merit is less than the selected threshold.

19. The wireless network of claim 18, wherein:
the radio access network optimization unit operates to determine that the figure of merit is below a threshold;
the radio access network optimization unit operates to mitigate the interference caused when the at least one sector of the sectorized supercell base station is activated if the figure of merit is below a threshold, comprising the radio access network optimization unit configured to:
allocate a first portion of available frequency spectrum to the plurality of macro-cells of the wireless network; and
allocate a second portion of the available frequency spectrum to the at least one sector of the sectorized supercell base station, wherein the first portion and the second portion do not overlap in the available frequency spectrum.

20. The wireless network of claim 18, wherein:
the radio access network optimization unit operates to determine that the figure of merit is below a threshold;
the radio access network optimization unit operates to mitigate the interference caused when the at least one sector of the sectorized supercell base station is activated if the figure of merit is below a threshold, comprising the radio access network optimization unit configured to:
allocate a first portion of an allocated time period to the plurality of macro-cells of the wireless network; and
allocate a second portion of the allocated time period to the at least one sector of the sectorized supercell base station, wherein the first portion and the second portion do not overlap in the allocated time period.

21. The method of claim 1, wherein the collecting further comprises receiving the one or more characteristics, of the received wireless signals, from one or more of the plurality of user equipment.

22. The method of claim 1, further comprising:
mitigating interference associated with the plurality of user equipment by adjusting beamforming pattern characteristics of the at least one sector of the sectorized supercell base station.

23. The wireless network of claim 12, wherein the controller is further configured to:
perform the collect by receiving the one or more characteristics, of the received wireless signals, from one or more of the plurality of user equipment.
